(19) United States
(12) Patent Application Publication
(10) Pub. No.: US 2005/0190944 A1
(43) Pub. Date: Sep. 1, 2005

(54) Unidirectional condenser microphone unit

(75) Inventors: Hiroshi Akino, Machida-shi (JP); Kazuhisa Kondo, Machida-shi (JP); Koji Takayama, Toyama-shi (JP)

Correspondence Address: HAUPTMAN KANESAKA BERNER PATENT AGENTS, SUITE 300, 1700 DIAGONAL RD, ALEXANDRIA, VA, 22314-2848, US

(73) Assignee: KABUSHIKI KAISHA AUDIO-TECHNICA, Machida-shi (JP)

(21) Appl. No.: 11/064,079

(22) Filed: Feb. 24, 2005

(30) Foreign Application Priority Data
Feb. 25, 2004 (JP) 2004-049409

(51) Int. Cl. H04R 5/00; H04R 9/08; H04R 11/04

(52) U.S. Cl. 381/369; 381/170

(57) ABSTRACT

The present invention provides a unidirectional condenser microphone unit that can suppress the occurrence of howling. In a unidirectional condenser microphone unit, a diaphragm 20 extended across a support ring 21 and a backplate 30 supported by an insulation cylinder 50 are arranged opposite each other via a spacer ring 40. A backside air chamber 31 is provided between the backplate 30 and the insulation cylinder 50. When the density of air is defined as ρ, sound velocity is defined as c, the effective vibration area of the diaphragm 20 is defined as S, and the volume of the backside air chamber 31 is defined as V, a stiffness s1 of the backside air chamber expressed by (ρ×c²×S²)/V is increased on the basis of the volume V of the backside air chamber to shift a resonance frequency of a unidirectional component contained in unidirectivity up to a frequency near a high-frequency reproduction limit.

### TECHNICAL FIELD

The present invention relates to a unidirectional condenser microphone unit, and more specifically, to a unidirectional condenser microphone unit that is unlikely to suffer howling.

### BACKGROUND ART

A unidirectional microphone comprises a front sound terminal and a back sound terminal. By selecting the distance between the sound terminals, an acoustic resistance material placed in the back sound terminal, and the like, it is possible to obtain a cardioid type polar pattern for a sound source present in a particular direction. However, if for example, the microphone is used close to a speaker, howling (oscillation) may occur.

The directional frequency response of the unidirectional microphone is the major cause of howling. Accordingly, in order to suppress the occurrence of howling, it is effective to improve the directional frequency response of the microphone.

The unidirectivity of the unidirectional microphone is realized by synthesizing a bidirectional component with a nondirectional component. However, for a condenser microphone, which is of an electrostatic type, the bidirectional component does not have any resonance point because it corresponds to resistance control. Further, the nondirectional component corresponds to elastic control and thus has a resonance point present in a high frequency side of the frequency response.

Near the resonance frequency, the phase rotates through 180° from +90° to −90°. Accordingly, the directional frequency response is degraded even with the synthesis into the unidirectivity. Thus, by designing the microphone such that the unidirectional component has as high a resonance frequency as possible, it is possible to realize a favorable directional frequency response up to a high frequency region.

However, since the unidirectional component corresponds to the elastic control, setting a high resonance frequency reduces sensitivity. Further, the sensitivity of the bidirectional component must be reduced consistently with decreasing sensitivity of the unidirectional component. This lowers the conversion efficiency of the microphone unit to degrade the sensitivity and the signal to noise ratio.

Thus, the conventional unidirectional condenser microphone (what is called a balanced microphone) is designed so that the unidirectional component has a resonance frequency of about 10 kHz so as to meet requirements for performances such as sensitivity, directional frequency response, and intrinsic noise. However, disadvantageously, 10 kHz is also an audible frequency band, and howling induced by phase rotations is likely to occur at 5 kHz or higher.

### SUMMARY OF THE INVENTION

It is thus an object of the present invention to provide a unidirectional condenser microphone unit which maintains a cardioid type polar pattern up to, for example, about 10 kHz and which can suppress the occurrence of howling.

To accomplish this object, the present invention provides a unidirectional condenser microphone unit in which a diaphragm extended across a support ring and a backplate supported by an insulation cylinder are arranged opposite each other via a spacer ring, a backside air chamber being provided between the backplate and the insulation cylinder, the microphone unit being characterized in that when the density of air is defined as ρ, sound velocity is defined as c, the effective vibration area of the diaphragm is defined as S, and the volume of the backside air chamber is defined as V, a stiffness s1 of the backside air chamber expressed by (ρ×c²×S²)/V is increased on the basis of the volume V of the backside air chamber to shift a resonance frequency of a unidirectional component contained in unidirectivity up to a frequency near a high-frequency reproduction limit.

Further, the unidirectional condenser microphone unit according to the present invention is characterized by compensating for a decrease in sensitivity corresponding to an increase in stiffness s1 by increasing the effective vibration area S of the diaphragm and/or a polarization voltage.

Moreover, the unidirectional condenser microphone unit according to the present invention is characterized in that in the unidirectional condenser microphone unit in which the resonance frequency of the nondirectional component is set at about 10 kHz, the stiffness s1 of the backside air chamber is increased by a factor of about 3.4 and the effective vibration area S of the diaphragm is increased by a factor of about 1.6 to shift the resonance frequency of the unidirectional component up to about 19 kHz without reducing the sensitivity.

According to the present invention, the resonance frequency of the nondirectional component contained in the unidirectivity is shifted up to a frequency (for example, about 19 to 20 kHz) near the high-frequency reproduction limit. This suppresses the occurrence of howling. Further, a decrease in sensitivity can be prevented by increasing the effective vibration area S of the diaphragm and/or the polarization voltage.

### BRIEF DESCRIPTION OF THE DRAWINGS

FIG. 1 is a sectional view showing the internal structure of a unidirectional condenser microphone unit according to the present invention,

FIG. 2 is a sectional view showing an essential part of the unidirectional condenser microphone unit;

FIG. 3 is a characteristic graph showing the directional frequency response of the unidirectional condenser microphone unit according to an embodiment of the present invention;

FIG. 4 is a graph showing a polar pattern observed at 6,000 Hz according to the embodiment,

FIG. 5 is a graph showing a polar pattern observed at 10,000 Hz according to the embodiment,

FIG. 6 is a characteristic graph showing the directional frequency response of a unidirectional condenser microphone unit according to a conventional example;

FIG. 7 is a graph showing a polar pattern observed at 6,000 Hz according to the conventional example; and

FIG. 8 is a graph showing a polar pattern observed at 10,000 Hz according to the conventional example.

### DETAILED DESCRIPTION

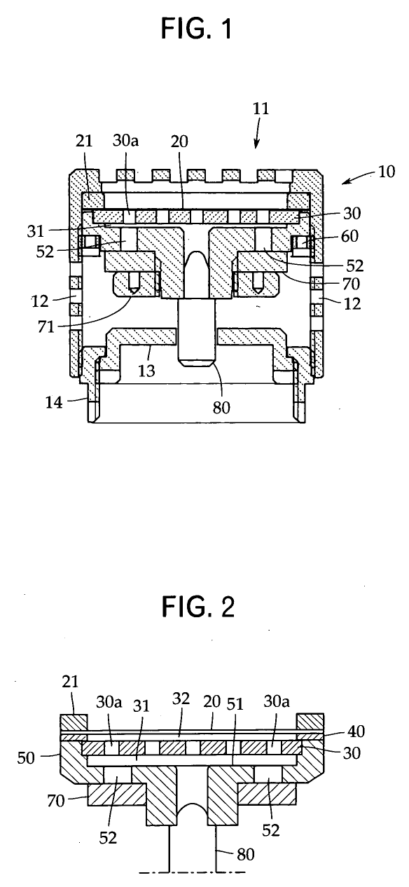

An embodiment of the present invention will be described below with reference to the drawings. However, the present invention is not limited to this. FIG. 1 is a sectional view showing the internal structure of a unidirectional condenser microphone unit. FIG. 2 is a sectional view showing an essential part of the unidirectional condenser microphone unit.

The unidirectional condenser microphone unit (sometimes simply referred to as a “microphone unit” below) comprises a casing 10 cylindrically formed as a housing. The casing 10 is provided with a front sound terminal 11 and a back sound terminal 12. In this example, the front sound terminal 11 consists of a grid-like opening formed at one end of the casing 10. The back sound terminal 12 is opened in a side of the casing 10.

Further, a back cover 13 and a cylindrical screw coupler 14 are provided at the other end of the casing 10; the screw coupler 14 is connected to a microphone main body (not shown). The casing 10 and the screw coupler 14 consist of a metal material such as brass because they must be conductive.

In the casing 10, a diaphragm 20 and a backplate 30 are arranged opposite each other via a spacer ring 40. The diaphragm 20 consists of a synthetic resin film of thickness about 5 mm for example which has a metal deposited film (not shown) on at least one surface. The diaphragm 20 is extended across the support ring 21 while subjected to a predetermined tension.

Although not shown, an electret material is applied to the backplate 30 in this example. A back side of the backplate 30 is supported by an insulation cylinder 50 made of a synthetic resin. The insulation cylinder 50 is pressed against the support ring 21 by a fixed ring 60 screwed into an inner surface of the casing 10.

The insulation cylinder 50 comprises a concave portion 51 so that the backside air chamber 31 is formed between the concave portion 51 and the back side of the backplate 30. A sound opening 52 is drilled in the insulation cylinder 50; the sound opening 52 is in communication with the backside air chamber 31 and the back sound terminal 12. Further, a large number of openings 30a are drilled in the backplate 30 so that the backside air chamber 31 is in communication with a thin air layer 32 present between the diaphragm 20 and the backplate 30.

An acoustic resistance material 70 consisting of a nylon mesh is provided at the bottom of the insulation cylinder 50 so as to cover the sound opening 52. The level of compression of the acoustic resistance material 70 can be adjusted using an adjust ring 71. Further, an electrode output rod 80 is attached to the insulation cylinder 50.

The electrode output rod 80 is connected to the backplate 30 via wiring (not shown) formed along an inner surface of the insulation cylinder 50. Further, when the microphone unit is coupled to the microphone main body via the screw coupler 14, the electrode output rod 80 is connected to an impedance converter (for example, an FET) provided in the microphone main body.

Those of the sound waves emitted by a sound source (not shown) which enter the front sound terminal act directly on a front surface of the diaphragm 20. On the other hand, sound waves entering the back sound terminal 12 pass through the acoustic resistance material 70, the sound opening 52, the backside air chamber 31, and opening 30a in the backplate 30 to the thin air layer 32. These sound waves act on a back side of the diaphragm 20.

Thus, the microphone unit operates as a unidirectional microphone. However, the unidirectivity is obtained by synthesizing a bidirectional component with a nondirectional component. The bidirectional component does not have any resonance point because it corresponds to resistance control performed by the acoustic resistance material 70 or the like. Further, the nondirectional component has a resonance point because it corresponds to elastic control.

That is, with a unidirectional microphone, the nondirectional component is the major cause of howling. According to the present invention, the occurrence of howling is suppressed by shifting the resonance frequency of the nondirectional component to the vicinity of the high-frequency reproduction limit of the microphone unit, for example, up to about 19 to 20 kHz.

In the condenser microphone, the elastic (spring) control mainly results from the tension of the diaphragm 20 and the stiffness of the backside air chamber 31. In view of, for example, quality and stability in mass production as practical problems, the stiffness of the backside air chamber 31 is easier to control than the tension of the diaphragm 20.

Thus, the present invention proposes that the stiffness of the backside air chamber 31 be increased to shift the resonance frequency of the nondirectional component to the vicinity of the high-frequency reproduction limit of the microphone unit, for example, up to about 19 to 20 kHz.

First, the mass of vicinity of the diaphragm including the masses of the diaphragm 20 itself and thin air layer 32 is defined as m0. The stiffness of the backside air chamber 31 is defined as s1. Then, the resonance frequency 1h of the nondirectional component is expressed as follows:
fh=1/2π×√s1/m0 (1)

Then, the density of air is defined as ρ, and sound velocity is defined as c. The effective vibration area of the diaphragm 20 is defined as S, and the volume of the backside air chamber 31 is defined as V. Then, the stiffness s1 of the backside air chamber 31 is determined by Equation (2).
s1=(ρ×c²×S²)/V (2)

Equations (1) and (2) indicate that the resonance frequency fh of the nondirectional component can be shift to a high frequency region by increasing the stiffness s1 of the backside air chamber 31 without varying the mass m0 of vicinity of the diaphragm. In order to increase the stiffness s1 of the backside air chamber 31 without varying the effective vibration area S of the diaphragm 20, it is possible to reduce the volume V of the backside air chamber 31 according to Equation (2) described above.

By thus designing the backside air chamber 31 so that it has a reduced volume V, it is possible to shift the resonance frequency of the nondirectional component to the vicinity of the high-frequency reproduction limit of the microphone unit, for example, up to 19 to 20 kHz. However, this on the other hand reduces the sensitivity. In order to solve the problem of the decrease in sensitivity, it is possible to increase the effective vibration area S of the diaphragm 20 and/or a polarization voltage.

### EXAMPLE

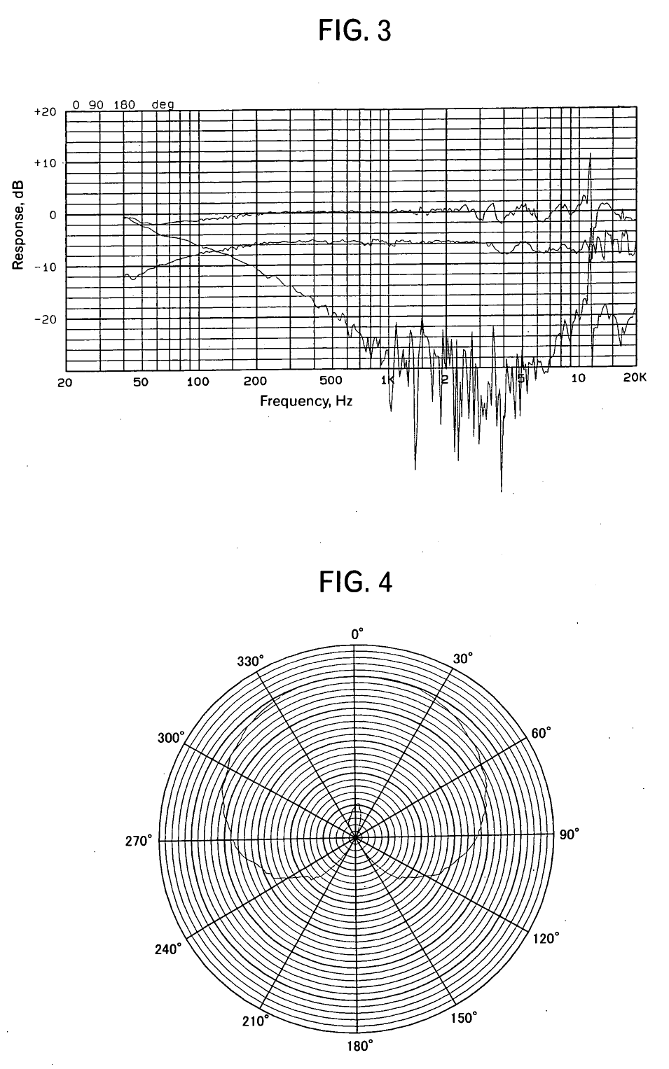

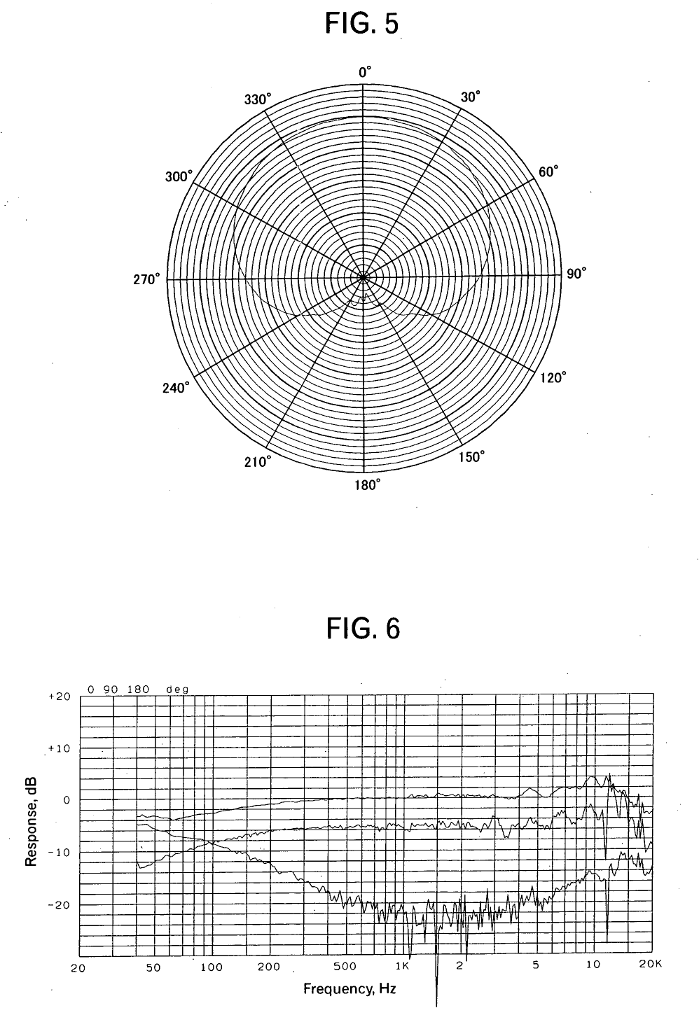

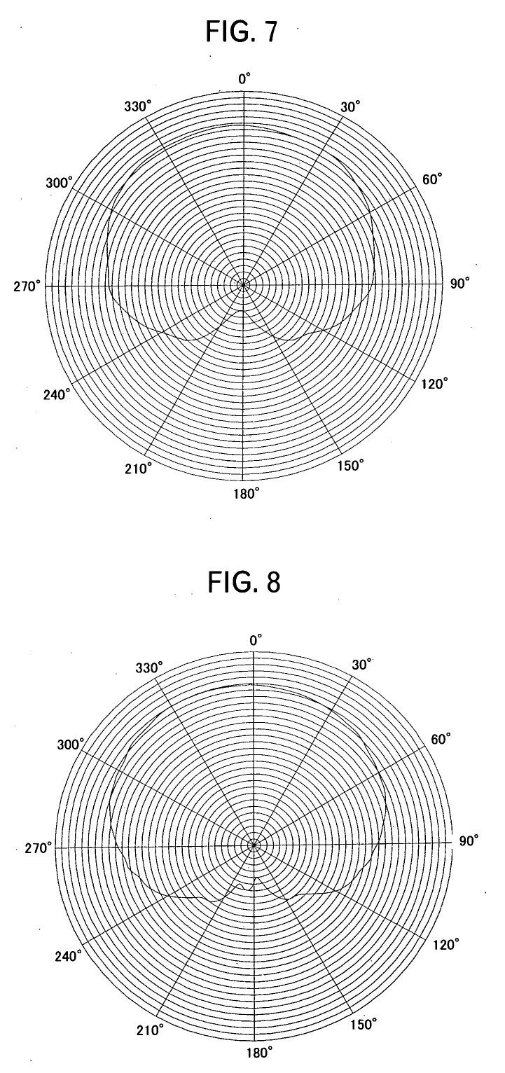

FIG. 3 is a characteristic graph of the directional frequency response of a unidirectional condenser microphone unit (Example 1) actually produced according to the present invention. FIGS. 4 and 5 show polar patterns observed at 6,000 Hz and 10,000 Hz, respectively, in Example 1. In contrast, FIG. 6 is a characteristic graph of the directional frequency response of a unidirectional condenser microphone unit (Conventional Example 1) produced according to the conventional design. FIGS. 7 and 8 show polar patterns observed at 6,000 Hz and 10,000 Hz, respectively, in Comparative Example 1. The items of Example 1 and Comparative Example 1 are shown below.

### Example 1

| | |
|---|---|
| Effective vibration area of diaphragm (S) | 0.4918653 cm² |
| Distance between sound terminals (d) | 1.05 cm |
| Mass of vicinity of diaphragm (m0) | 7.13 × 10⁻¹ g |
| Volume of backside air chamber (V) | 1.74 × 10⁻² cm³ |
| Stiffness of backside air chamber (s1) | 1.96 × 10⁷ dyn/cm |
| Resonance frequency (fh) | 19061 Hz |
| Polarization voltage (Eb) | 157.2 V |
| Sensitivity (V/Pa) | 9.31 × 10⁻³ |
| Signal to noise ratio | 71.9 dB |
| Dynamic range | 115.18 dB |

(In the unit of sensitivity (V/Pa), V denotes the output voltage of the microphone and Pa denotes a pressure including a sound pressure. That is, the sensitivity is the output voltage of the microphone per pascal).

### Conventional Example 1

| | |
|---|---|
| Effective vibration area of diaphragm (S) | 0.30772 cm² |
| Distance between sound terminals (d) | 1.3 cm |
| Mass of vicinity of diaphragm (m0) | 7.73 × 10⁻⁴ g |
| Volume of backside air chamber (V) | 2.33 × 10⁻² cm³ |
| Stiffness of backside air chamber (s1) | 5.72 × 10⁶ dyn/cm |
| Resonance frequency (fh) | 10155 Hz |
| Polarization voltage (Eb) | 94.9 V |
| Sensitivity (V/Pa) | 6.47 × 10⁻³ |
| Signal to noise ratio | 71.3 dB |
| Dynamic range | 108.43 dB |

As described above, in Example 1, compared to Conventional Example 1, the stiffness (s1) of the backside air chamber is increased by a factor of about 3.4, and a decrease in sensitivity caused by the increase in the stiffness (s1) is compensated for by increasing the effective vibration area of the diaphragm by a factor of about 1.6 and raising the polarization voltage (Eb).

In Conventional Example 1, the resonance frequency (fh) is about 10 kHz. However, in Embodiment 1, the resonance frequency (fh) is about 19 kHz, which is about twice the value obtained in the conventional example. Further, for the polar pattern, in Example 1, the cardioid is deformed at 6,000 Hz or higher as seen in FIGS. 7 and 8. Accordingly, howling is likely to occur in a band equal to or higher than this frequency.

In contrast, according to Example 1, the shape of the cardioid is maintained up to about 10 kHz as shown in FIGS. 4 and 5. Accordingly, in this frequency region, howling is unlikely to occur. Howling is prone to occur if the polar pattern is irregular, so that the phase is likely to rotate.

The preferred embodiment of the present invention has been described. However, the present invention is not limited to this embodiment. Of course, the technical scope of the present invention includes many variations and modifications that will occur to those skilled in the art of microphones and having ordinary technical knowledge in the art.

1. A unidirectional condenser microphone unit in which a diaphragm extended across a support ring and a backplate supported by an insulation cylinder are arranged opposite each other via a spacer ring, a backside air chamber being provided between the backplate and the insulation cylinder,
wherein when the density of air is defined as ρ, sound velocity is defined as c, the effective vibration area of the diaphragm is defined as S, and the volume of the backside air chamber is defined as V, a stiffness s1 of the backside air chamber expressed by (ρ×c²×S²)/V is increased on the basis of the volume V of the backside air chamber to shift a resonance frequency of a unidirectional component contained in unidirectivity up to a frequency near a high-frequency reproduction limit.

2. The unidirectional condenser microphone unit according to claim 1, wherein a decrease in sensitivity corresponding to an increase in stiffness s1 is compensated for by increasing the effective vibration area S of the diaphragm and/or a polarization voltage.

3. The unidirectional condenser microphone unit according to claim 1, wherein in the unidirectional condenser microphone unit in which the resonance frequency of the nondirectional component is set at about 10 kHz, the stiffness s1 of the backside air chamber is increased by a factor of about 3.4 and the effective vibration area S of the diaphragm is increased by a factor of about 1.6 to shift the resonance frequency of the unidirectional component up to about 19 kHz without reducing the sensitivity.
